(19) United States
(12) Patent Application Publication
(10) Pub. No.: US 2014/0285662 A1
(43) Pub. Date: Sep. 25, 2014

(54) IMAGE PROCESSING APPARATUS, AND METHOD

(71) Applicant: FUJITSU LIMITED, Kawasaki-shi (JP)

(72) Inventor: Kimitaka MURASHITA, Atsugi (JP)

(73) Assignee: FUJITSU LIMITED, Kawasaki-shi (JP)

(21) Appl. No.: 14/169,718

(22) Filed: Jan. 31, 2014

(30) Foreign Application Priority Data
Mar. 19, 2013 (JP) 2013-057137

(51) Int. Cl. H04N 7/18

(52) U.S. Cl. CPC H04N 7/183
USPC 348/148; 348/222.1

(57) ABSTRACT

An image processing apparatus includes: a memory; and a processor coupled to the memory and configured to: acquire image data, and extract a corner point from the image data, based on brightness information of plurality of pixels in image data, the corner point corresponding to a pixel arranged in a first edge of a horizontal direction and a second edge of the vertical direction, when a number of pixels arranged in each of the first and second edges is more than certain value.

### CROSS-REFERENCE TO RELATED APPLICATION

This application is based upon and claims the benefit of priority of the prior Japanese Patent Application No. 2013-057137, filed on Mar. 19, 2013, the entire contents of which are incorporated herein by reference.

### FIELD

The embodiments discussed herein are related to a technique for detecting feature points from digital images.

### BACKGROUND

Corner detection methods are known techniques with which feature points in images are extracted. In corner detection methods, for example, a Harris operator or a SUSAN operator is used to detect, as feature points, corners in the shapes of objects within an image. A corner is a pixel that is the intersecting point of two edges, and a corner detection method extracts such pixels as feature points.

It is known that jaggies are generated in digital images. Jaggies are step-like jagged sections that may be seen in the contours of objects and characters in images. Since digital images are expressed by a plurality of pixels lined up in a regular manner in the X-axis direction or the Y-axis direction, portions that are not parallel to the X-axis or Y-axis direction of the image from among the contours of an object or a character are expressed in the form of steps, and jaggies are thus generated. Since jaggies are generated in the form of steps, the pixels corresponding to the jaggies make up edges in two directions.

For example, Japanese Laid-open Patent Publication No. 2011-43969 discloses an image feature point extraction method in which unnecessarily extracted points are excluded from feature points extracted by various operators for detecting corners. In this image feature point extraction method, for example, a plurality of image data produced by an image having been changed by affine transformation is acquired, and in each item of image data, feature points are extracted by various operators.

Then, in this image feature point extraction method, positions in the image prior to the change that correspond to the feature points extracted from the items of image data are obtained. Then, only feature points that are extracted in association with the change in the image are selected, and other points are excluded as unnecessarily extracted feature points.

### SUMMARY

According to an aspect of the invention, an image processing apparatus includes: a memory; and a processor coupled to the memory and configured to: acquire image data, and extract a corner point from the image data, based on brightness information of plurality of pixels in image data, the corner point corresponding to a pixel arranged in a first edge of a horizontal direction and a second edge of the vertical direction, when a number of pixels arranged in each of the first and second edges is more than certain value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A and FIG. 1B are drawings for illustrating feature point candidates derived from jaggies, and feature point candidates derived from an object;

FIG. 2 is a functional block diagram of an image processing apparatus;

FIG. 3A and FIG. 3B are drawings for illustrating a first method for designating feature point candidates derived from jaggies (first thereof);

FIG. 4A and FIG. 4B are drawings for illustrating the first method for designating feature point candidates derived from jaggies (second thereof);

FIG. 5A and FIG. 5B are drawings for illustrating a second method for designating feature point candidates derived from jaggies;

FIG. 6 is a flowchart of an image processing method;

FIG. 7 is a flowchart according to the first method for designating feature point candidates derived from jaggies;

FIG. 8 is a flowchart according to the second method for designating feature point candidates derived from jaggies; and

FIG. 9 is a hardware configuration example for an image processing apparatus.

### DESCRIPTION OF EMBODIMENTS

According to the abovementioned image feature point extraction method, it is possible to distinguish between feature points derived from jaggies and feature points derived from objects or the like captured in an image, and to extract the feature points derived from objects or the like.

However, in order to extract feature points derived from objects or the like from an image captured at a certain point in time, it is desirable for a plurality of image data to be generated. Together with the increase in processing load relating to generating a plurality of image data, it is desirable for a storage region for retaining the plurality of image data to be ensured.

Thus, in one aspect, an objective of the present technique is to efficiently extract, as feature points, the corners of objects in an image.

Detailed embodiments of the present technique are described hereinafter. The following embodiments may also be combined, as appropriate, as long as the content of the processing is not contradicted. Hereinafter, the embodiments are described on the basis of the drawings.

First, a corner detection method in which a Harris operator is employed is briefly described. A Harris operator is also used in the present embodiments. However, the technique disclosed in the present embodiments is not restricted to a Harris operator, and it is possible to employ another operator such as a Moravec operator.

A Harris operator is an operator for computing, on the basis of the brightness information of pixels in an image, a feature quantity that is dependent upon the edge intensity in each of the X-axis direction and the Y-axis direction, and the correlation with the periphery. Various operators apart from the Harris operator that are used in corner detection methods compute feature quantities on the basis of the brightness information of pixels in an image. A feature quantity is a value that is dependent upon the edge intensities of pixels in each of the X-axis direction and the Y-axis direction, and the correlation with the periphery.

Feature quantities become larger values for pixels having high edge intensities in both the X-axis direction and the Y-axis direction. That is, a pixel having a large feature quantity is a pixel that has a high possibility of having a side that makes up a horizontal edge and a side that makes up a vertical edge. Furthermore, feature quantities become larger values when, in an image, there is little correlation between a rectangle centered on a certain pixel and a rectangle centered on a neighboring pixel. That is, a pixel having little correlation with the periphery is a pixel for which the possibility of being a pixel in an end portion of an edge is higher than the possibility of being a pixel in the central portion of an edge.

A conventional corner detection method is described hereafter. In a conventional corner detection method, pixels that form corners are detected as feature points on the basis of feature quantities obtained by a Harris operator. For example, pixels having feature quantities that are equal to or greater than a threshold value are detected as pixels that form corners.

However, in the present embodiments, as described later, corners that are derived from jaggies are excluded from feature-point extraction targets. That is, corners derived from objects are extracted. For example, in the present embodiments, pixels that are detected on the basis of feature quantities are, first, set as feature point candidates. In addition, the feature point candidates derived from jaggies are removed from the feature point candidates, and the remaining feature point candidates are detected as feature points that are derived from objects.

The feature point candidates in the present embodiments include pixels having a high possibility of being corners derived from jaggies and corners derived from objects. However, the feature points that are finally extracted include feature point candidates produced by the feature point candidates derived from jaggies having been excluded from the extracted feature point candidates by processing that is described later.

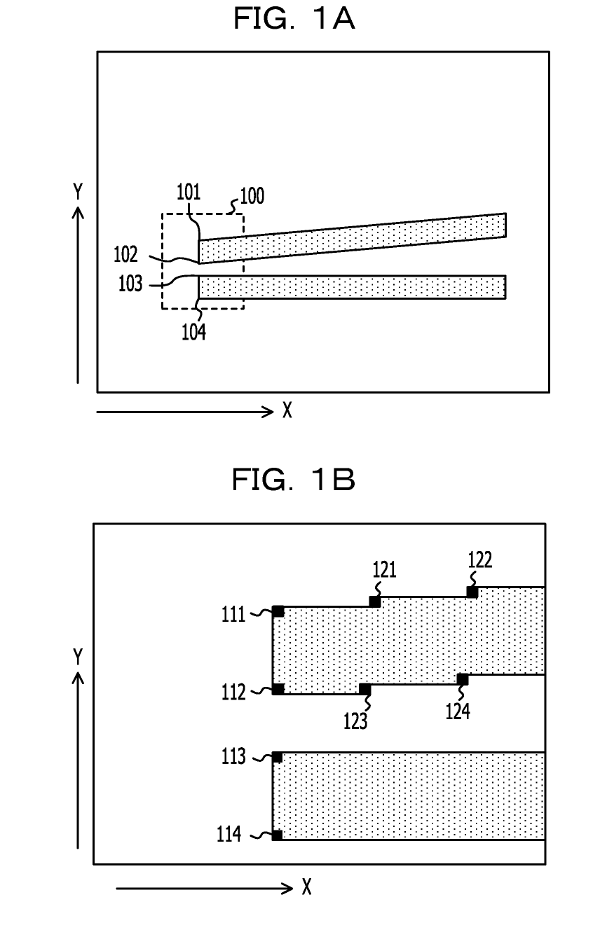

Hereafter, the feature point candidates and the feature points in the present embodiments are described in greater detail. FIG. 1A and FIG. 1B are drawings for illustrating feature point candidates derived from jaggies and feature point candidates derived from an object. FIG. 1A is a drawing depicting the entirety of a captured image, and X and Y represent the arrangement directions of pixels.

In the image depicted in FIG. 1A, two quadrilateral objects have been captured. The contours of one of the two quadrilaterals are parallel with the arrangement directions of the pixels. However, at least some of the contours of the other quadrilateral are not parallel with the arrangement directions of the pixels. In the captured image depicted in FIG. 1A, originally, the points of 101, 102, 103, and 104 for example are recognized as feature points derived from the quadrilateral objects.

Furthermore, FIG. 1B is a drawing for illustrating feature point candidates derived from jaggies. Moreover, FIG. 1B is a drawing in which region 100 in FIG. 1A has been enlarged. The pixels of 121, 122, 123, and 124 are not parallel to the arrangement directions of the pixels, and are corners derived from jaggies that have been generated in order to express the contours of the object. According to a conventional corner detection method, as depicted in FIG. 1B, there is a possibility that the pixels of 121, 122, 123, and 124 will be detected as feature point candidates other than 111, 112, 113, and 114 that correspond to 101, 102, 103, and 104 in FIG. 1A. The reason for this is because conventional feature quantities become large values for pixels having a high possibility of being corners, and it is therefore not possible to distinguish between corners derived from jaggies and corners derived from objects.

Feature points derived from jaggies generated due to the arrangement of pixels, originally, ought not to be detected as feature points. In the present embodiments, feature point candidates derived from jaggies are excluded from among feature point candidates, and definitive feature points are detected. For example, the feature point candidates 121, 122, 123, and 124 that are derived from jaggies are excluded from among the feature point candidates 111, 112, 113, 114, 121, 122, 123, and 124, and feature points 111, 112, 113, and 114 are detected.

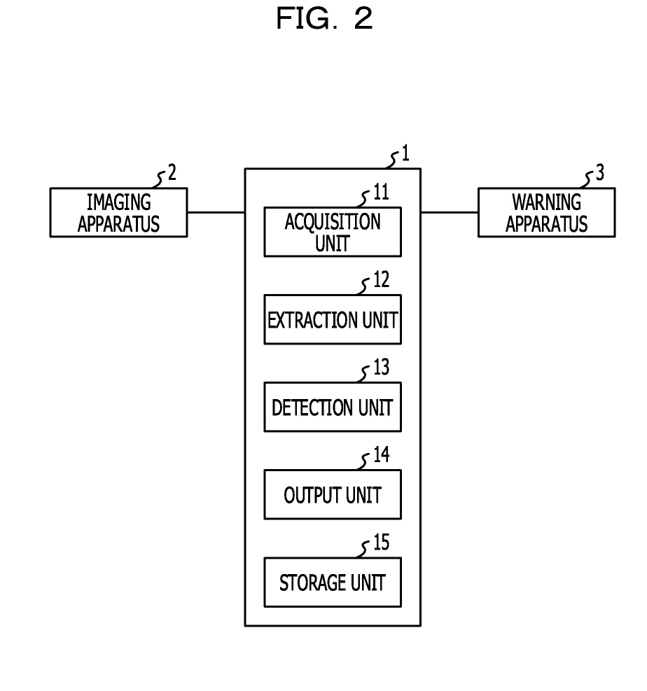

Next, the functional configuration of an image processing apparatus according to the present embodiments is described using FIG. 2. FIG. 2 is a functional block diagram of an image processing apparatus.

The image processing apparatus according to the present embodiments detects feature points, and also uses the detected feature points to execute specific processing. For example, the image processing apparatus extracts, from a plurality of pixels, feature points derived from objects, and also associates feature points among the plurality of pixels. An approaching object within the image is detected from the movement of the associated feature points.

Moreover, the image processing apparatus may output feature point detection results to another apparatus, and the other apparatus may execute detection processing for approaching objects. Furthermore, the image processing apparatus may compute the movement speed of a mobile body on which an imaging apparatus is mounted, from the movement of the associated feature points. In this way, the image processing apparatus is able to use, in various processing, the feature points extracted by the method according to the present embodiments.

The image processing apparatus 1 is a computer that executes extraction processing for feature points according to the present embodiments. The imaging apparatus 2 is an apparatus that captures images that are targets for feature point extraction. For example, the imaging apparatus 2 is a camera that captures images at fixed frame intervals. The warning apparatus 3 is an apparatus that issues a warning regarding the presence of an approaching object by display or audio. For example, the warning apparatus 3 is a car navigation system provided with a display and a speaker.

In the present embodiments, the image processing apparatus 1 and the imaging apparatus 2 are communicably connected. Furthermore, the image processing apparatus 1 and the warning apparatus 3 are also communicably connected. Moreover, at least one of the image processing apparatus 1 and the imaging apparatus 2 or the image processing apparatus 1 and the warning apparatus 3 may be connected via a network.

The image processing apparatus 1 is provided with an acquisition unit 11, an extraction unit 12, a detection unit 13, an output unit 14, and a storage unit 15.

The acquisition unit 11 sequentially acquires image data from the imaging apparatus 2. The image data referred to here is data relating to an image that has been captured by the imaging apparatus 2. The image data includes at least brightness information of pixels. Furthermore, the image data may include color information such as RGB.

Furthermore, the image depicted in FIG. 1A is the result of rendering processing being executed on the basis of image data. Moreover, as occasion calls, the warning apparatus 3 may acquire image data from the imaging apparatus 2, and an image may be displayed on a display of the warning apparatus 3.

The extraction unit 12 extracts feature points from an image. The extraction unit 12 determines on the basis of brightness information whether a plurality of pixels form an edge, in which a plurality of pixels are arranged, in the vertical direction and the horizontal direction, and also extracts feature points that indicate corners, on the basis of the determination result.

For example, if the plurality of pixels form an edge, in which a plurality of pixels are arranged, in the vertical direction and the horizontal direction, the extraction unit 12 extracts, as a feature point, the pixel corresponding to a corner from among the pixels forming the edge in question. However, in the acquired image data, the extraction unit 12 does not extract, as feature points, pixels forming an edge, in which a single pixel is arranged, in the vertical direction and the horizontal direction.

An example of the extraction of feature points is hereafter described in a more specific manner. For example, the extraction unit 12 extracts feature quantities on the basis of brightness information included in image data. In addition, if a Harris operator is used, the feature quantity dst(x,y) is computed on the basis of expression 1. Furthermore, it is preferable for k to be a number between 0.04 and 0.15. Moreover, M that is used in the computation of dst(x,y) is obtained from expression 2. Here, the coefficient k is an adjustable parameter, dI/dx is the horizontal inclination of a brightness value I, and dI/dy is the vertical inclination.

$$\begin{matrix}dst ( x , y ) = det {M}^{( x , y )} - k \cdot {( tr {M}^{( x , y )} )}^{2} & ( expression 1 ) \\ M = [ \begin{matrix}{\sum }_{S ( p )}^{ } {( \frac{d I}{d x} )}^{2} & {\sum }_{S ( p )}^{ } {( \frac{d I}{d x} \cdot \frac{d I}{d y} )}^{2} \\ {\sum }_{S ( p )}^{ } {( \frac{d I}{d x} \cdot \frac{d I}{d y} )}^{2} & {\sum }_{S ( p )}^{ } {( \frac{d I}{d y} )}^{2}\end{matrix} ] & ( expression 2 )\end{matrix}$$

Next, the extraction unit 12 extracts feature point candidates on the basis of the feature quantities of the pixels. For example, a pixel having a feature quantity that is equal to or greater than a threshold value is extracted as a feature point candidate. Furthermore, the extraction unit 12 may extract, as a feature point candidate, the pixel having the largest feature quantity from among N number of neighboring pixels centered on a certain pixel. For example, the pixel having the largest feature quantity from among the four pixels above, below, to the left, and to the right of a certain pixel serving as a center point is extracted.

Furthermore, the feature quantities may be binarized prior to the extraction of feature point candidates. For example, the feature quantities are binarized. In this case, the processing described hereinafter may be executed on the basis of binarized feature quantities.

Next, the extraction unit 12 designates feature point candidates derived from jaggies. That is, in the acquired image data, the extraction unit 12 designates pixels forming an edge, in which a single pixel is arranged, in the vertical direction and the horizontal direction. Examples of the designation method include a first method for directly detecting edges in which a single pixel is arranged, and a second method for indirectly detecting edges in which a single pixel is arranged.

In the first method, the extraction unit 12 obtains edge widths on the basis of the brightness values of pixels, in each of the X-axis direction and the Y-axis direction. An edge width is the number of pixels forming an edge (gap length). If there is an edge having a width of 1, the extraction unit 12 designates the feature point candidate that corresponds to the pixel forming the edge having a width of 1, as a feature point candidate derived from a jaggy.

Furthermore, in the second method, the extraction unit 12 compares the feature quantities of feature point candidates, and the feature quantities of neighboring pixels of the feature point candidates. Neighboring pixels are, for example, pixels that are adjacent above, below, to the left, and to the right of a certain feature point candidate.

The extraction unit 12 designates feature point candidates derived from jaggies on the basis of the comparison result. If a pixel having a feature quantity similar to the feature quantity of a feature point candidate is included in the neighboring pixels, it is determined that the feature point candidate is a feature point candidate that is derived from a jaggy. Moreover, if the difference between the feature quantity of a neighboring pixel and the feature quantity of a feature point candidate is equal to or less than a fixed value, or if the feature quantity of the neighboring pixel is within ±β% of the feature quantity of the feature point candidate, it is determined that the feature point candidate is a feature point candidate that is derived from a jaggy. For example, β is 10.

Furthermore, the extraction unit 12 may change the value of β in accordance with the magnitude of a feature quantity. For example, if a value having a magnitude of approximately 1,000 is included in the feature quantities of pixels, β is set to approximately 50. For example, in dark pixels, the distribution of the brightness values of the pixels becomes smaller. Consequently, feature quantities that are dependent upon edge intensity become comparatively small values even with respect to pixels that correspond to edges.

Furthermore, in bright pixels, the distribution of the brightness values of the pixels becomes larger. Consequently, feature quantities that are dependent upon edge intensity become comparatively large values with respect to pixels that correspond to edges. Therefore, the extraction unit 12 appropriately controls the threshold value (β) in accordance with the features of the image.

Then, after the feature point candidates that are derived from jaggies have been designated, the extraction unit 12 removes the feature point candidates derived from jaggies, from among the feature point candidates. The extraction unit 12 then outputs, to the detection unit 13, the remaining feature point candidates as the feature point extraction result.

In this way, the feature point extraction method implemented by the extraction unit 12 focuses on the notion that edges derived from jaggies are edges having a width of 1. By using this feature, it is possible to remove feature point candidates derived from jaggies even when a known corner detection method is used. That is, the extraction unit 12 is able to precisely detect feature points derived from objects, from an image in which image data is expressed.

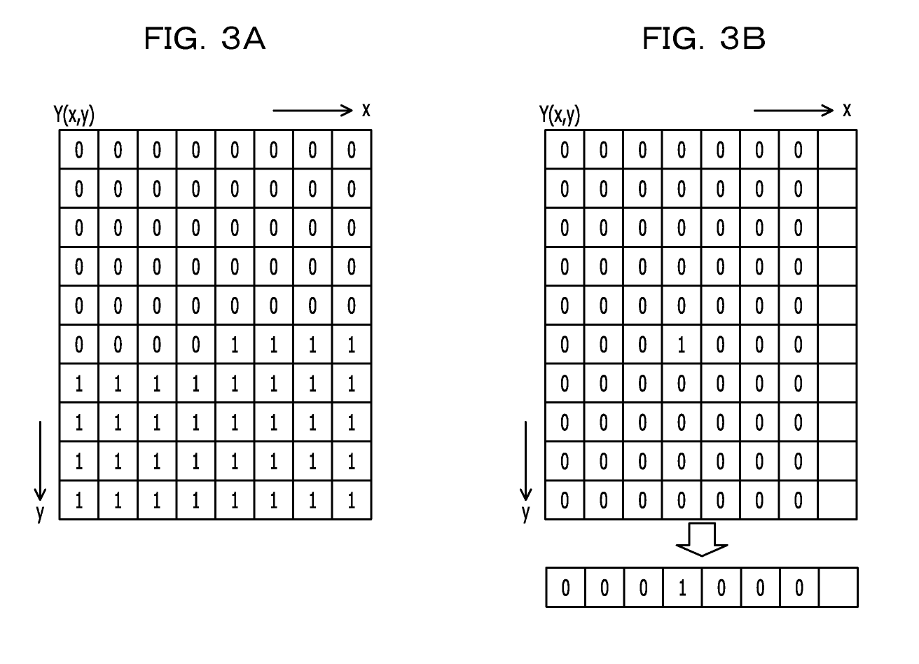

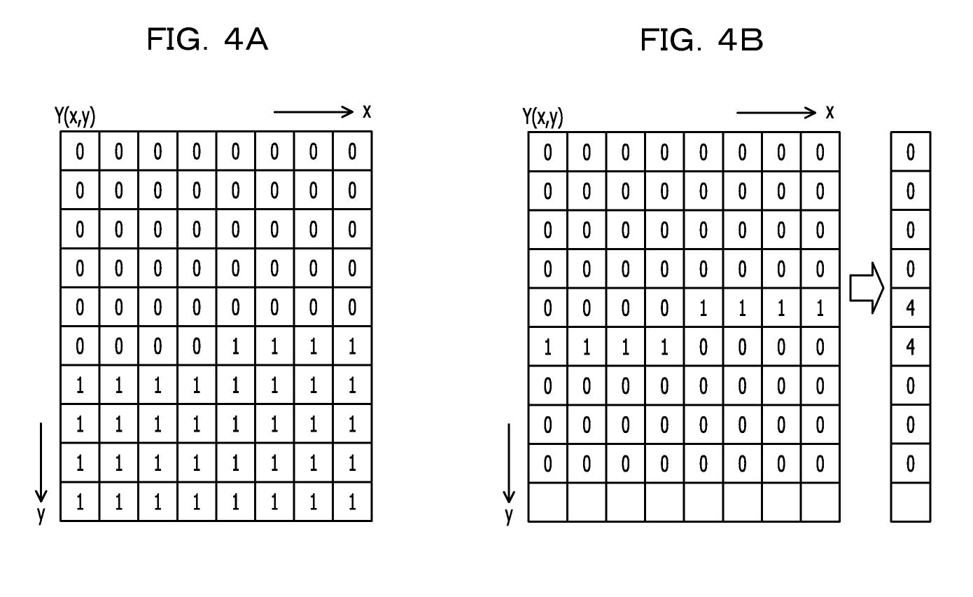

FIG. 3A and FIG. 3B and also FIG. 4A and FIG. 4B are used to illustrate the first method for designating feature point candidates derived from jaggies. FIG. 3A and FIG. 3B and also FIG. 4A and FIG. 4B are drawings for illustrating the first method for designating feature point candidates derived from jaggies. The rectangles represent pixels, and the values depicted within the rectangles represent pixel values that are based on brightness values.

First, the case where the width of an edge extending in the y-axis direction is obtained is described using FIG. 3A and FIG. 3B. FIG. 3A is a binarized image of image data that is generated on the basis of brightness information and acquired by the acquisition unit 11. Each of the pixels Y(x,y) has a value of 0 or 1. Moreover, the values given to the pixels due to the binarization are referred to as pixel values.

Next, FIG. 3B is a drawing depicting the result of obtaining the difference between the pixel value of Y(a+1,b) and the pixel value of Y(a,b) for the pixels Y(x,y). That is, FIG. 3B is the result of detecting an edge extending in the y-axis direction. For each column (each position in the x direction), the extraction unit 12 counts the number of continuous pixels having a difference of 1. For the counting result, the fourth column from the left indicates “1”, and the other columns are “0”.

The extraction unit 12 determines that there is an edge having a width of 1 in the column indicating a counting result of 1. It is judged that the pixel indicating 1 in the upper drawing of FIG. 3B is a pixel forming an edge having a width of 1. That is, in the upper drawing of FIG. 3B, the pixel that is fourth from the left and sixth from the top is a pixel forming an edge having a width of 1. The feature point candidate corresponding to this pixel is a feature point candidate derived from a jaggy.

In the binary image of FIG. 3A, in the case where a pixel value of 0 (white) serves as a reference, the pixel that is fourth from the left and sixth from the top corresponds to a corner. On the other hand, in the case where a pixel value of 1 (black) serves as a reference, the pixel that is fifth from the left and sixth from the top corresponds to a corner. As large feature quantities are given to these two pixels according to a conventional operator, these two pixels are extracted as feature point candidates in the present embodiments.

Thus, if a left-side pixel is to serve as a reference when the difference between the pixel values of two pixels is obtained, the extraction unit 12 also excludes, from feature point candidates, the pixel that is adjacent to the right side of a pixel forming an edge having a width of 1. For example, in the example of FIG. 3B, the pixel (the pixel that is fifth from the left and sixth from the top) that is adjacent to the right side of the pixel that is fourth from the left and sixth from the top is also excluded from the feature point candidates.

Likewise, if a right-side pixel is to serve as a reference when a difference is obtained, the pixel that is adjacent to the left side is also excluded from the feature point candidates.

Next, the case where the width of an edge extending in the x-axis direction is obtained is described using FIG. 4A and FIG. 4B. FIG. 4A is the same binarized image as FIG. 3A. FIG. 4B is a drawing depicting the result of obtaining the difference between the pixel value of Y(a,b+1) and the pixel value of Y(a,b) for the pixels Y(x,y). For each row (each position in the y direction), the extraction unit 12 counts the number of continuous pixels having a difference of 1. For the counting result, the fifth and sixth rows from the top indicate “4” and the other rows are “0”.

That is, it is clear that the pixels indicating 1 in the left drawing of FIG. 4B are pixels that form an edge having a width of 4 (or greater), in the x-axis direction. In other words, it is indicated that, in the image of FIG. 4A, there are no edges having a width of 1 in the x-axis direction. Consequently, in the case of FIG. 4A, a feature point candidate derived from a jaggy is not designated with regard to the x-axis direction.

Moreover, as in FIG. 3A and FIG. 3B, if the upper-side pixel is to serve as a reference when the difference between the pixel values of two pixels is obtained, the extraction unit 12 also excludes, from the feature point candidates, the pixel that is adjacent to the lower side of a pixel that forms an edge having a width of 1. Likewise, if the lower-side pixel is to serve as a reference when a difference is obtained, the pixel that is adjacent to the upper side is also excluded from the feature point candidates.

Furthermore, the processing described in FIG. 3A and FIG. 3B and also FIG. 4A and FIG. 4B may be performed for each region with the pixels having been divided into n number of regions, and if an edge derived from a jaggy is determined by performing processing in raster scan order from the top left end of the image, the counting result up to that edge is reset to 0, counting is started once more from that position, and all of the pixels within the image are processed.

For example, due to the processing described in FIG. 3A and FIG. 3B and also FIG. 4A and FIG. 4B, the extraction unit 12 directly detects edges in which single pixels are arranged. The extraction unit 12 designates, as pixels of feature point candidates derived from jaggies, pixels forming an edge having a width of 1, in either of the x-axis direction and the y-axis direction.

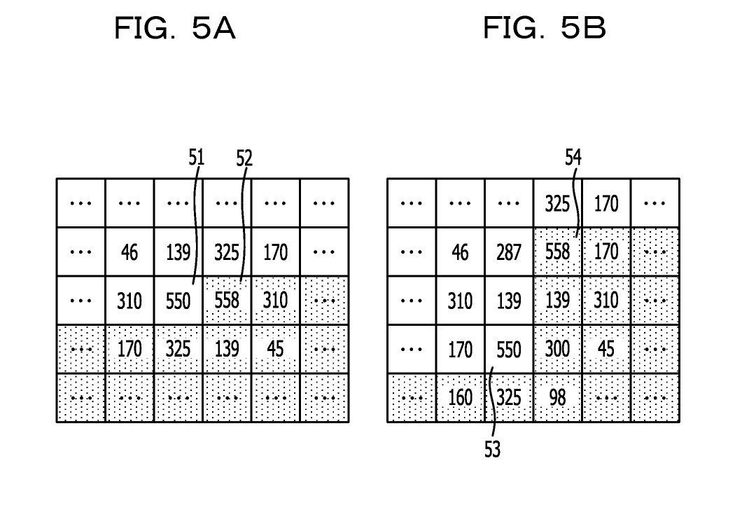

Next, the second method for designating feature point candidates derived from jaggies is described using FIG. 5A and FIG. 5B. FIG. 5A and FIG. 5B are drawings for illustrating the second method for designating feature point candidates derived from jaggies. The rectangles represent pixels, and the values depicted in the rectangles represent the feature quantities of the pixels when a Harris operator is used. The extraction unit 12 extracts pixels having a feature quantity of 512 or greater as feature point candidates.

For example, in FIG. 5A, pixel 51 and pixel 52 are extracted as feature point candidates. The feature quantity “550” of the pixel 51 that is a feature point candidate is compared with each of the feature quantities of the four pixels above, below, to the left, and to the right. In this case, the feature quantity “558” of pixel 52 that is adjacent to the right of pixel 51 is a value that is within ±10% of the feature quantity “550” of pixel 51. Consequently, it is determined that pixel 51 of the feature point candidates is a feature point candidate derived from a jaggy. Furthermore, also in the case where the same determination is performed with the pixel 51 that is a feature point candidate serving as a reference, it is determined that the feature point candidate corresponding to pixel 52 is a feature point candidate derived from a jaggy.

As in FIG. 5A, in the case where pixel 51 and pixel 52 that indicate a corner mutually form an edge having a width of 1, pixel 51 is a corner when viewed from the pixels depicted in white in FIG. 5A, and pixel 52 is a corner when viewed from the shaded pixels. That is, the adjacent pixel 51 and pixel 52 both have large feature quantities. Therefore, it is possible to use the feature quantities of pixels adjacent to feature point candidates in order to designate feature point candidates that are derived from jaggies. The same processing implemented by the extraction unit 12 is described with FIG. 5B as an example. For example, in FIG. 5B, pixel 53 and pixel 54 are extracted as feature point candidates. The extraction unit 12 compares the feature quantity of pixel 53 and the feature quantities of pixels that are adjacent above, below, to the left, and to the right of pixel 53. In the example of FIG. 5B, it is determined that the feature quantity of pixel 53 that is a feature point candidate, and the feature quantities of the pixels that are adjacent above, below, to the left, and to the right are not similar. That is, pixel 53 that is a feature point candidate is not designated as a feature point candidate derived from a jaggy. Furthermore, the same is also true for pixel 54 that is a feature point candidate.

As described above, in the present embodiments, the extraction unit 12 processes image data acquired by the acquisition unit 11 and focuses on edge width, and the extraction unit 12 distinguishes between feature points indicating corners derived from objects and points indicating corners derived from jaggies, and performs extraction.

Furthermore, in the present embodiments, if an edge width is 1 in the image data acquired by the acquisition unit 11, it is considered to indicate a corner derived from a jaggy. That is, if the image data acquired by the acquisition unit 11 is enlarged, an edge derived from a jaggy would also come to be formed from a plurality of pixels corresponding to the enlargement ratio. Consequently, the extraction unit 12 deems that, in an enlarged image, edges formed from a plurality of pixels corresponding to the enlargement ratio are edges that are formed from a single pixel in the original image data.

If the acquired image data is subjected to enlargement processing prior to feature point extraction processing, in the first method for designating feature point candidates derived from jaggies, the extraction unit 12 designates, in accordance with an enlargement ratio α, feature point candidates that form edges having a width of 1, in the original image data. Edges having a width of 1 in the original image data are edges having a width of α in the enlarged image. The extraction unit 12 extracts, as feature points, feature point candidates other than feature point candidates forming edges of the enlargement ratio α.

Furthermore, in the second method for designating feature point candidates derived from jaggies, the extraction unit 12 sets pixels within a range corresponding to the enlargement ratio α as neighboring pixels, and as targets for comparison with the feature quantity of a feature point candidate. That is, not only pixels that are adjacent above, below, to the left, and to the right but also a number of pixels above, below, to the left, and to the right are set as targets. Consequently, if the feature quantities of a number of pixels above, below, to the left, and to the right are not similar to the feature quantity of a feature point candidate, the extraction unit 12 extracts the feature point candidate as a feature point.

Here, we return to the description of FIG. 2. The detection unit 13 uses the feature points extracted by the extraction unit 12 to detect an approaching object. Moreover, as previously described, other than the detection of an approaching object, other processing may be executed using the extracted feature points.

For example, the detection unit 13 associates feature points extracted from newly acquired image data, and feature points extracted from image data acquired one time period before. A conventionally known method is applied for the association of feature points.

The detection unit 13 then computes the optical flow for each of the feature points. The detection unit 13 then detects an approaching object on the basis of the optical flow. A conventionally known method is applied for the detection of an approaching object.

Here, the processing of the detection unit 13 is briefly described for the case where the imaging apparatus 2 is mounted on a vehicle. Furthermore, via a controlled-area network (CAN) within the vehicle, the image processing apparatus 1 acquires information (CAN signals) relating to the movement state of the vehicle. For example, speed information detected by a vehicle speed sensor, and information relating to turning detected by a steering angle sensor are acquired by the image processing apparatus 1.

The detection unit 13 determines whether or not there is an approaching object on the basis of the movement state of the vehicle. For example, when the vehicle has moved forward, feature points in an object corresponding to the background exhibit an optical flow that flows from the inside to the outside, between an image at time T1 and an image at time T2. However, if there is an approaching object such as a person or a car, the feature points derived from the approaching object exhibit an optical flow that flows from the outside to the inside, between an image at time T1 and an image at time T2. The detection unit 13 detects an approaching object from the optical flow of associated feature points between images by utilizing these kinds of properties.

Moreover, the detection unit 13 is able to detect not only approaching objects but also moving objects. In this case, the detection unit 13 takes into consideration not only the direction of optical flow vectors but also the magnitude thereof. For example, if there is an optical flow having a magnitude that is different to the magnitude of an optical flow relating to background feature points, the detection unit 13 detects that a moving object is present.

Furthermore, the detection unit 13 is able to associate feature points between an image of time T1 and an image of time T2, and is also able to obtain the speed of the vehicle from the feature quantities of the feature points.

Here, the extraction of object-derived feature points from images is important from the aspect of highly accurate feature point extraction. Additionally, this is even more important in the case where feature points are associated among a plurality of images as in the processing performed by the detection unit 13.

Ordinarily, the position of a feature point in an image is decided by the positional relationship between an object and the imaging apparatus. That is, in a plurality of images captured at predetermined frame intervals, if the position of the imaging apparatus 2 changes as time elapses, the positions of feature points derived from objects also change. As previously described, this property is used in the detection of an approaching object and the computation of the speed of a mobile body.

However, feature points derived from jaggies do not change in a regular manner in accordance with the positional relationship between an object and the imaging apparatus 2. The reason for this is because jaggies are generated when the contours of an object are expressed by regularly arranged pixels, and the positions where jaggies are generated are dependent upon the shape of the contours and the arrangement of the pixels.

Therefore, if a feature point candidate derived from a jaggy is also extracted as a feature point, the feature point derived from the jaggy does not exhibit properties such as those of a feature point derived from an object, which therefore leads to a decrease in the precision of the processing of subsequent stages. That is, regardless of there being an approaching object, because a feature point derived from a jaggy is extracted, there is a possibility of an optical flow exhibiting a flow corresponding to an approaching object, which gives rise to erroneous detection. Furthermore, it is not possible to obtain an accurate speed if the speed of a mobile body is computed using the extracted feature points.

However, processing having greater precision becomes possible as a result of the detection unit 13 using the feature points extracted by the extraction unit 12 of the present embodiments. That is, in FIG. 1, if only feature points 111, 112, 113, and 114 are detected, the detection unit 13 is able to perform, with greater accuracy, processing such as detecting an approaching object and obtaining the speed of a mobile body.

Furthermore, as previously described, jaggies are generated when curved lines and diagonal lines are expressed in a digital image. Here, besides cases where the shape of an object is actually constituted by curved lines or diagonal lines, there are also often cases where curved lines and diagonal lines are generated depending upon the properties of the imaging apparatus 2.

A field of view corresponding to the angle of view of the imaging apparatus 2 is captured in the imaging apparatus 2. The imaging apparatus 2 then expresses information of the captured field of view using vertically and horizontally arranged pixels. That is, the angle of view is limited by the pixel arrangement. In this way, for example, there are cases where the field of view is expressed with curved lines in an image even if constituted by straight lines in real space. Consequently, jaggies are generated in the image.

In an image captured by a camera mounted with a wide-angle lens or the like, since the contours of an object are rendered with substantially curved lines, there is a greater demand for feature point candidates derived from jaggies to be removed. For example, vehicle-mounted cameras are often mounted with the objective of capturing a wider field of view, and often have a wide-angle lens or a super-wide-angle lens.

Next, the output unit 14 in FIG. 2 outputs, to the warning apparatus 3, warning information based on the detection results of the detection unit 13. For example, the warning information is information that warns of the presence of an approaching object.

The storage unit 15 stores information to be used for various processing, image data, and feature point detection results and so on. The information for various processing is, for example, information relating to threshold values. Furthermore, the storage unit 15 may retain image data acquired within a fixed period, and also detection results on feature points extracted from the image data.

The imaging apparatus 2 is an apparatus that captures images. The imaging apparatus 2 transmits image data representing the captured images to the image processing apparatus 1.

The warning apparatus 3 is an apparatus that, as occasion calls, issues warnings to a user. For example, the warning apparatus 3 executes warning processing on the basis of warning information received from the image processing apparatus 1. The warning information is implemented by display or audio.

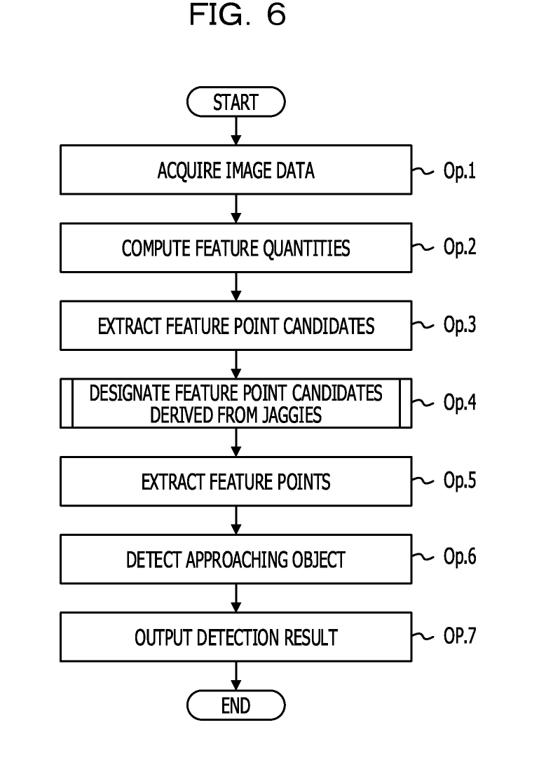

Next, the processing flow of the image processing apparatus 1 is described using FIG. 6. FIG. 6 is a flowchart of an image processing method.

The acquisition unit 11 acquires image data from the imaging apparatus 2 (Op. 1). Next, the extraction unit 12 computes the feature quantities of pixels on the basis of the image data (Op. 2). Feature quantities are obtained on the basis of the edge intensity in each of the X-axis direction and the Y-axis direction, and the correlation with peripheral pixels.

The extraction unit 12 extracts feature point candidates on the basis of the feature quantities of pixels (Op. 3). For example, a pixel having a feature quantity that is equal to or greater than a threshold value, or the pixel having the largest feature quantity from among N number of neighboring pixels, is extracted as a feature point candidate.

Next, the extraction unit 12 designates feature point candidates derived from jaggies, from among the feature points extracted in Op. 3 (Op. 4). The processing for designating feature point candidates derived from jaggies is described later.

In Op. 4, the extraction unit 12 designates pixels making up edges having a width of 1, and thereby excludes the pixels in question from the feature points extracted in Op. 5. In other words, the extraction unit 12 determines whether a plurality of pixels included in the image data form an edge in which a plurality of pixels are arranged in the vertical direction and the horizontal direction. The extraction unit 12 then clarifies, on the basis of the determination result, the feature points to be extracted in the following Op. 5.

The extraction unit 12, on the basis of the results of Op. 4, then extracts feature points from among the feature point candidates extracted in Op. 3 (Op. 5). For example, the extraction unit 12 excludes, from the feature point candidates extracted in Op. 3, the feature point candidates designated in Op. 4 as feature point candidates derived from jaggies. That is, the remaining feature point candidates are extracted as feature points.

The extraction unit 12 outputs, together with the image data, the position information (coordinates) of the pixels of the feature points to the detection unit 13. In addition, the extraction unit 12 also stores the position information of the feature points together with the image data in the storage unit 15.

Next, the detection unit 13 performs detection for an approaching objects on the basis of the position information of the pixels of the feature points and the image data (Op. 6). For example, reference is made to the storage unit 15, and the image data of one time period before and the position information of the feature points in the image data in question are acquired. The detection unit 13 then performs detection for an approaching object on the basis of the optical flow of feature points associated between images. If an approaching object is detected, the detection unit 13 generates warning information for notifying the presence of the approaching object, and also outputs the warning information to the output unit 14.

The output unit 14 outputs the warning information to the warning apparatus 3 (Op. 7). However, Op. 7 is omitted if the detection unit 13 has not detected an approaching object.

As described above, in accordance with the image processing method disclosed in the present embodiments, the image processing apparatus is able to extract feature points derived from objects. Furthermore, if processing using the extracted feature points is executed, it is likely that there will be an improvement in the precision of the processing.

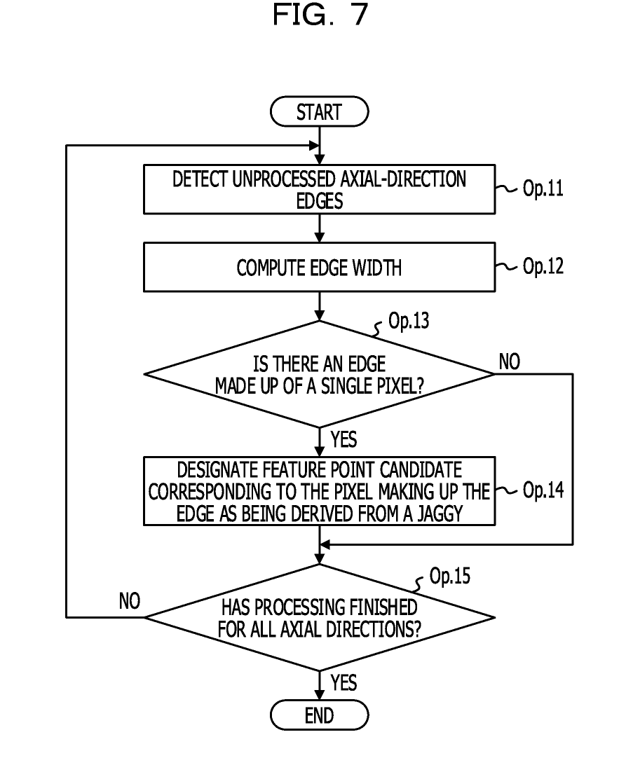

Here, the processing of Op. 4 is described in detail. Each of the processing flows is indicated with respect to the first method depicted in the previous FIG. 3A and FIG. 3B and also FIG. 4A and FIG. 4B, and the second method depicted in FIG. 5A and FIG. 5B. First, FIG. 7 is a flowchart according to the first method for designating feature point candidates derived from jaggies.

The extraction unit 12 detects unprocessed edges in axial directions, on the basis of the brightness information of pixels included in image data (Op. 11). For example, the Y-axis direction is first set as a processing target.

Next, the extraction unit 12 computes the width of a detected edge (Op. 12). Here, the width of an edge is expressed by the number of pixels forming the edge. For example, as depicted in FIG. 3B, the extraction unit 12 counts the number of continuous 1 pixel values with respect to each column. Furthermore, if there are a plurality of edges, the width is computed for each of the edges.

Next, on the basis of the computed width edges, the extraction unit 12 determines whether there is an edge made up of a single pixel among the edges detected in Op. 11 (Op. 13). That is, it is determined whether or not there is an edge having a width of 1.

If there is an edge made up of a single pixel (Op. 13 YES), the extraction unit 12 designates the pixel making up the edge, and also designates the feature point candidate corresponding to the pixel, as a feature point candidate derived from a jaggy (Op. 14).

Moreover, as previously described, here it is determined that not only the pixel making up the edge but also a pixel having a specific positional relationship with the pixel is, likewise, a pixel representing a feature point candidate derived from a jaggy. Furthermore, if there are a plurality of edges made up of a single pixel, the same processing is performed for each edge.

If there are no edges made up of a single pixel (Op. 13 NO), or after the processing of Op. 14 has finished, the extraction unit 12 determines whether the processing has finished with respect to all axial directions (Op. 15). If the processing has not finished (Op. 15 NO), the extraction unit 12 executes processing from Op. 11 with a new axial direction as the processing target. For example, the same processing is executed for the X-axis direction. If the processing has finished (Op. 15 YES), the processing for designating feature point candidates derived from jaggies ends.

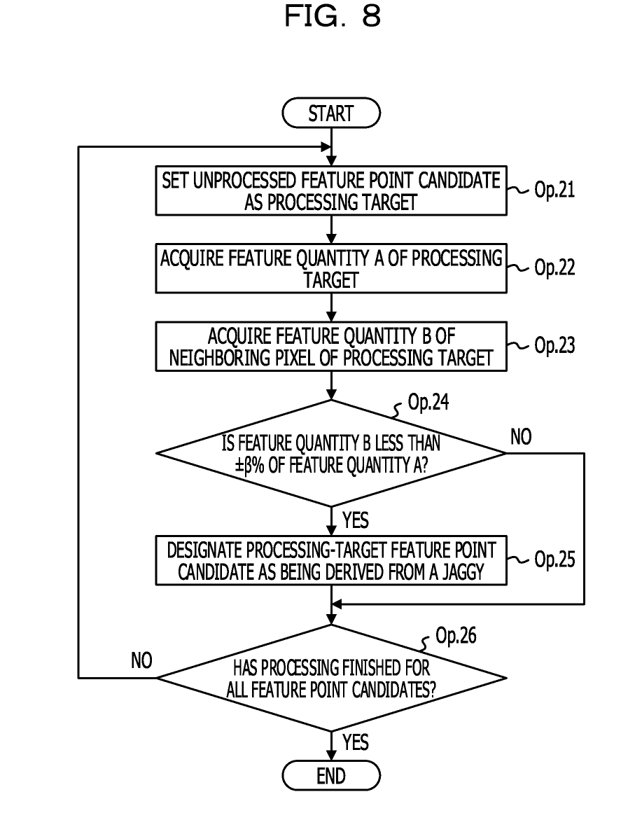

Next, FIG. 8 is a flowchart according to the second method for designating feature point candidates derived from jaggies. The extraction unit 12 sets, from among the processing candidates extracted in Op. 3, an unprocessed feature point candidate as a processing target (Op. 21).

The extraction unit 12 then acquires the feature quantity A of the processing-target feature point candidate (Op. 22). In addition, the extraction unit 12 acquires feature quantities B also for neighboring pixels of the pixel of the processing-target feature point candidate (Op. 23). For example, the feature quantities B of each of the four neighboring pixels that are adjacent above, below, to the left, and to the right of the pixel of the feature point candidate are acquired.

Next, the extraction unit 12 determines whether a feature quantity B is less than ±β of the feature quantity A (Op. 24). Among the feature quantities B of the plurality of neighboring pixels, there ought to be at least one feature quantity that is a value less than ±β of the feature quantity A.

If the feature quantity B is a value less than ±β of the feature quantity A (Op. 24 YES), the processing-target feature point candidate is designated as a feature point candidate derived from a jaggy (Op. 25). If the feature quantity B is a value not less than ±β of the feature quantity A (Op. 24 NO), or after the processing of Op. 25 has finished, the extraction unit 12 determines whether the processing has finished with respect to all feature point candidates (Op. 26).

If the processing has not finished (Op. 26 NO), the extraction unit 12 executes processing from Op. 21 with a new feature point candidate as the processing target. If the processing has finished (Op. 26 YES), the processing for designating feature point candidates derived from jaggies ends.

As depicted in FIG. 7 and FIG. 8, the present embodiments focuses on the notion that edges derived from jaggies are expressed by single pixels in the original image data acquired by the acquisition unit 11, and distinguishes between feature point candidates derived from objects and feature point candidates derived from jaggies. That is, the image processing apparatus 1 is able to extract feature points representing corners derived from objects, on the basis of edges made up of a plurality of pixels.

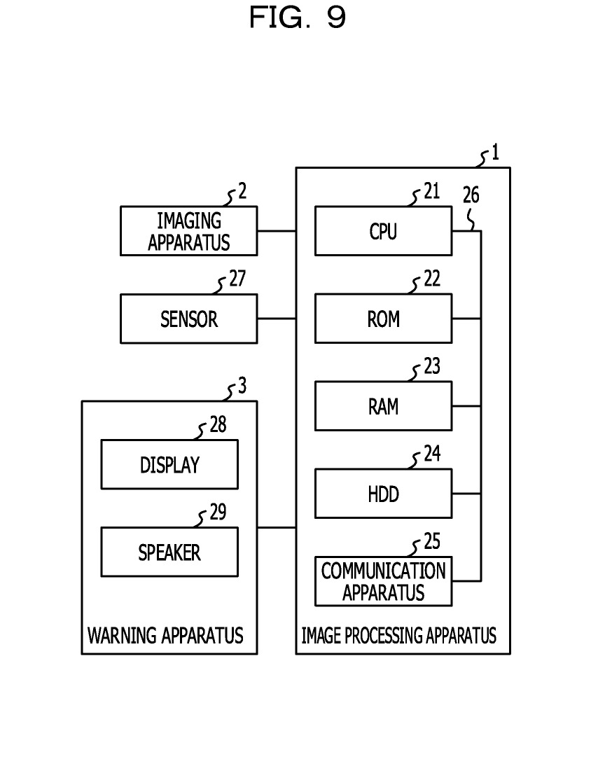

Next, the hardware configuration of the image processing apparatus 1 is described. FIG. 9 is a drawing depicting an example of a hardware configuration of the image processing apparatus 1.

The image processing apparatus 1 is realized in terms of hardware by a memory and a processor capable of accessing the memory. That is, the image processing apparatus 1 includes a processor that executes the image processing according to the present embodiments, and a memory that stores a program according to the image processing. When the processor executes the image processing, the processing is executed in accordance with a program read out from the memory. In addition, other than the program, the memory may also store information to be used for the image processing method according to the present embodiments.

The hardware configuration in the case where the image processing apparatus 1 is a computer is described in a more specific manner using FIG. 9. The computer has a central processing unit (CPU) 21, a read-only memory (ROM) 22, a random-access memory (RAM) 23, a hard disk drive (HDD) 24, and a communication apparatus 25. These units are connected to each other via a bus 26. It is therefore possible for the transmission and reception of data to be mutually performed under control implemented by the CPU 21.

An image processing program in which the image processing depicted in the flowcharts of the embodiments is written may be recorded on a computer-readable recording medium. Examples of a computer-readable recording memory are a magnetic recording apparatus, an optical disc, a magneto-optical recording medium, and a semiconductor memory and so on. Examples of a magnetic recording apparatus are a HDD, a flexible disk (FD), and a magnetic tape (MT) and so on.

Examples of an optical disc are a digital versatile disc (DVD), a DVD-RAM, a compact disc read-only memory (CD-ROM), a compact disc-recordable (CD-R), and a compact-disc rewritable (CD-RW) and so on. An example of a magneto-optical recording medium is a magneto-optical disc (MO) or the like. If this program were circulated, for example, it is considered that portable recording media such as DVDs and CD-ROMs having the program recorded thereon would be sold.

In the case where the computer that executes the image processing program is additionally provided with a media reading apparatus, the program is read out from a recording medium on which the image processing program has been recorded. The CPU 21 stores the program that has been read out, in the HDD 24, or in the ROM 22 or the RAM 23.

The CPU 21 is a central processing apparatus that manages the operational control of the entirety of the image processing apparatus 1. The CPU 21 is an example of the processor provided in the image processing apparatus 1. The CPU 21 reads out the image processing program from the HDD 24 and executes the image processing program, and the CPU 21 thereby functions as the extraction unit 12 and the detection unit 13 depicted in FIG. 2. As previously described, the image processing program may be stored in the ROM 22 or the RAM 23 that are able to be accessed with the CPU 21.

Next, the communication apparatus 25 functions as the acquisition unit 11 and the output unit 14 under the control of the CPU 21. Furthermore, the communication apparatus 25 may be an apparatus that manages communication that passes through a network, or an apparatus that manages communication that does not pass through a network.

In addition, the HDD 24 functions as the storage unit 15 depicted in FIG. 2, under the management of the CPU 21. That is, the HDD 24 stores threshold value information and so on to be used for the image processing. As with the program, the threshold value information and so on to be used for the image processing may be stored in the ROM 22 or the RAM 23 that are able to be accessed with the CPU 21.

In addition, image data and feature-point position information that is generated over the course of the processing is stored in the RAM 23, for example. That is, there are also cases where the RAM 23 functions as the storage unit 15.

The imaging apparatus 2 is, for example, a camera. The imaging apparatus 2 captures images at predetermined frame intervals, and outputs, to the image processing apparatus 1, digital signals from among captured information that is converted into digital signals. The imaging apparatus 2 has, for example, a charge-coupled apparatus (CCD) sensor or a complementary metal-oxide semiconductor (CMOS) sensor.

A sensor 27 detects a variety of information, and also outputs detected information to the image processing apparatus 1. For example, in the case where the image processing apparatus 1 processes images captured by the imaging apparatus 2 mounted on a mobile body, the sensor 27 is a pulse sensor or a steering angle sensor. The sensor 27 detects information relating to the vehicle speed or the steering angle.

The warning apparatus 3 has a display 28 and a speaker 29. In addition, a car navigation system may function as the warning apparatus 3. The warning apparatus 3 issues warnings on the basis of warning information output from the image processing apparatus 1.

The display 28 displays a screen under the control of a processor provided in the warning apparatus 3. For example, the display displays a warning information screen relating to an approaching object. Furthermore, the speaker 29 outputs audio under the control of the processor provided in the warning apparatus 3. For example, the speaker 29 outputs a warning sound relating to an approaching object.

### Modified Example 1

It is also possible for the image processing apparatus 1 to be executed with the flowchart depicted in FIG. 6 being modified as follows. For example, after Op. 1 and Op. 2, the extraction unit 12 determines whether or not pixels are feature point candidates. Op. 4 is executed if a processing-target pixel is a feature point candidate. On the other hand, if a processing-target pixel is not a feature point candidate, or if Op. 4 has finished, the extraction unit 12 sets a new pixel as a processing target. After processing has finished for all pixels, the processing from Op. 5 to Op. 7 is executed.

### Modified Example 2

The embodiment depicted in FIG. 6 is restricted to extracting feature points after feature point candidates have been extracted. For example, rather than extracting a feature point candidate, the extraction unit 12 detects an edge that is made up of a plurality of pixels, and also detects, as a feature point, a pixel that is included in the edge and has a feature quantity that is equal to or greater than a fixed value. For example, the width of an edge is obtained by the method depicted in FIG. 3A and FIG. 3B and also FIG. 4A and FIG. 4B, for example.

### Modified Example 3

In the case where the imaging apparatus 2 is provided on a mobile body, and the image processing apparatus 1 detects approaching objects, processing for designating feature point candidates derived from jaggies may be executed when the mobile body is moving. This is because feature point candidates derived from jaggies and feature point candidates derived from the background do not move while the mobile body is stopped even as time elapses. Conversely, feature point candidates of a moving object such as an approaching object move as time elapses. That is, regardless of whether or not there are feature point candidates derived from jaggies, the image processing apparatus 1 is able to detect moving objects if the mobile body is stationary. Consequently, an image processing method that includes the extraction of feature points disclosed in the present embodiments may be executed with the objective of accurately detecting moving objects only when the mobile body is moving.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing apparatus comprising:
a memory; and
a processor coupled to the memory and configured to:
acquire image data, and
extract a corner point from the image data, based on brightness information of plurality of pixels in image data, the corner point corresponding to a pixel arranged in a first edge of a horizontal direction and a second edge of the vertical direction, when a number of pixels arranged in each of the first and second edges is more than certain value.

2. The image processing apparatus according to claim 1,
wherein the processor does not extract another corner point corresponding to another pixel arranged in a third edge of the horizontal direction and a forth edge of the vertical direction, when only one pixel is arranged in the third edge or the forth edge.

3. The image processing apparatus according to claim 2,
wherein the processor is further configured to:
based on the first, second, third, and forth edges, extract feature point candidates from among the plurality of pixels, the feature point candidates including the corner and the another corner,
exclude the another corner, from among feature point candidates, and
determine that rest of the feature point candidates is the corner.

4. The image processing apparatus according to claim 3,
wherein the processor is further configured to determine whether each of the first, second, third, and forth edges are arranged by only one pixel, based on the brightness information.

5. The image processing apparatus according to claim 3,
wherein the processor is further configured to determine, based on feature point candidates and neighboring pixels of the feature point candidates, whether the feature point candidate are forming the third edge or the forth edge arranged by the only one pixel.

6. The image processing apparatus according to claim 5,
wherein the neighboring pixels are adjacent to the feature point candidates.

7. The image processing apparatus according to claim 5,
wherein the processor is further configured to
compute feature quantities for each of the plurality of pixels on the basis of the brightness information, and
when first feature quantities of the feature point candidates and second feature quantities of the neighboring pixels are similar, determine that feature point candidates forming the third edge or the forth edge arranged by the only one pixel.

8. The image processing apparatus according to claim 1,
wherein the image data is acquired from an imaging apparatus, and
the processor is further configured to detect an approaching object with respect to a mobile body on which the imaging apparatus is mounted, based on changes in positions of the corner in the image data and in other image data captured before the image data.

9. The image processing apparatus according to claim 2,
wherein the processor is further configured to determine the third edge is arranged by the only one pixel, when a first pixel and a second pixel are assigned different value regarding the brightness information, the second pixel is next to the first pixel in the vertical direction.

10. The image processing apparatus according to claim 9,
wherein the processor is further configured to determine the forth edge is arranged by the only one pixel, when the first pixel and a third pixel are assigned different value regarding the brightness information, the third pixel is next to the first pixel in the horizontal direction.

11. An image processing method, the image processing method comprising:
acquiring image data; and
extracting a corner point from the image data, based on brightness information of plurality of pixels in image data, the corner point corresponding to a pixel arranged in a first edge of a horizontal direction and a second edge of the vertical direction, when a number of pixels arranged in each of the first and second edges is more than certain value.

12. A vehicle comprising:
a memory; and
a processor coupled to the memory and configured to:
acquire image data from an imaging apparatus which is mounted on the vehicle,
extract a corner point from the image data, based on brightness information of plurality of pixels in image data, the corner point corresponding to a pixel arranged in a first edge of a horizontal direction and a second edge of the vertical direction, when a number of pixels arranged in each of the first and second edges is more than certain value,
detect an approaching object with respect to the vehicle, based on changes in positions of the corner in the image data and other image data captured before the image data, and
execute a process for controlling the vehicle, when the approaching object is detected.
